(19) United States
(12) Patent Application Publication
(10) Pub. No.: US 2006/0073889 A1
(43) Pub. Date: Apr. 6, 2006

(54) Progressive gaming system and machines with partial payout

(76) Inventors: Orrin J. Edidin, Northbrook, IL (US); Michael W. Mastropietro, Chicago, IL (US)

Correspondence Address: Schwegman, Lundberg, Woessner & Kluth, P.A., P.O. Box 2938, Minneapolis, MN, 55402, US

(21) Appl. No.: 11/241,253

(22) Filed: Sep. 30, 2005

Related U.S. Application Data
(60) Provisional application No. 60/615,150, filed on Oct. 1, 2004.

(51) Int. Cl. G06F 19/00

(52) U.S. Cl. 463/27

(57) ABSTRACT

New progressive gaming machines and systems and related methods and components offer players opportunities to win a portion of a progressive jackpot. In one exemplary system, one or more gaming machines in a system payout a portion of a progressive jackpot value in response to a progressive winning event, with the pay amount determined as the ratio of the denomination of the winning machine to a maximum available denomination.

### RELATED APPLICATION

This application claims priority under 35 U.S.C. 119(e) from U.S. Provisional Application Ser. No. 60/615,150 filed 1 Oct. 2004, which application is incorporated herein by reference.

### TECHNICAL FIELD

Various embodiments of the present invention concern gaming machines and systems, particularly progressive gaming machines and systems.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Gaming machines, such as slot machines, have enjoyed great success and popularity in the gaming industry. Their appeal with players generally hinges on the perceived chances of winning and level of entertainment relative to other available gaming options. All other factors being equal, players generally prefer to play the most entertaining and exciting machines.

In recent years, stand-alone progressive gaming machines and progressive gaming systems have been introduced to further attract and entertain players. Progressive jackpots are jackpots that increase progressively as long as game play continues without reward of the jackpot. Thus, in a stand-alone progressive gaming machine, each successive losing play (that is, play that does not result in award of the jackpot) grows the jackpot, creating a greater incentive for users to continue play. A winning play, such as an alignment of three sevens or other reel symbols on a slot machine, results in award of the jackpot to the winning player and reset of the jackpot to a smaller value for further increase and eventual award to a winning player.

In a progressive gaming system, two or more gaming machines are linked together, and the progressive jackpot is increased more rapidly based on the collective play at separate machines. This linkage not only creates a greater incentive to continue play than in a stand-alone progressive machine, but also generates excitement among the players as they compete for an ever increasing jackpot.

Although progressive gaming machines and systems have proven very successful, there remains a continuing desire for new machines and systems.

### SUMMARY

Accordingly, the present inventors devised, among other things, new progressive gaming machines and systems and related methods and components that offer players opportunities to win a portion of a progressive jackpot. In one exemplary system, one or more gaming machines in a system display a single progressive jackpot value and payout out less than the jackpot value in response to a progressive winning event, with the pay amount determined as the ratio of the denomination of the winning machine to a maximum available denomination. In some embodiments, the denomination of each machine in the progressive system is a user selectable parameter, and the maximum denomination used to compute the amount of payout is the maximum user selectable denomination among all machines in the system.

### BRIEF DESCRIPTION OF THE DRAWINGS

FIG. 1 is a block diagram of an exemplary progressive gaming machine 100 which corresponds to one or more embodiments of the invention.

FIG. 2 is a flow chart that shows an exemplary method of operating gaming machine 100, and that corresponds to one or more embodiments of the invention.

FIG. 3 is a block diagram of an exemplary progressive gaming system 300, which corresponds to one or more embodiments of the present invention.

### DETAILED DESCRIPTION OF EXEMPLARY EMBODIMENTS

This description, which references and incorporates one or more drawings, describes and illustrates one or more exemplary embodiments of the invention. These embodiments, offered not to limit but only to exemplify and teach the concepts of the invention, are shown and described in sufficient detail to enable those skilled in the art to make and use the invention. Thus, where appropriate to avoid obscuring the invention, the description may omit certain information known to those of skill in the relevant art.

### Exemplary Gaming Machine

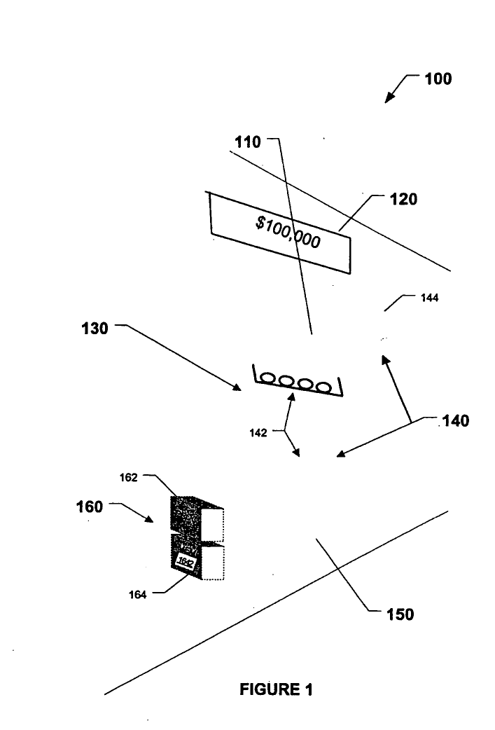

FIG. 1 shows an exemplary gaming machine 100 which is operable to conduct a wagering game and which incorporates one or more teachings of the present invention. Exemplary wagering games include slots, card games, such as video poker, or other types of wagering games, such as video keno, video bingo, or a video dice game. In various embodiments, the gaming machine takes the form of a multi-line video or multi-reel mechanical machine. More specifically, gaming machine 100 includes a primary game (video) display 110, a secondary game display 120, credit-receiving module 130, user interface 140, a payout module 150, and a control module 160.

Primary game display 110 displays one or more game indicators, such as two or more reels, playing cards, etc. In various embodiments, game display 110 takes the form of a cathode ray tube (CRT), liquid crystal display (LCD), plasma, or other type of video display. In the exemplary embodiment, gaming machine 100 has an “upright” form factor, which orients display 110 vertically relative to a player; however, in some embodiments, machine 100 has a “slant-top” form factor, which tilts display 110 at about a thirty-degree angle from horizontal toward the player. Other embodiments may have adjustable display angles.

Secondary game display 120 includes a video, LCD, or LED display. In the exemplary embodiment, display 120 displays a single progressive jackpot amount. In some embodiments, it displays two or more jackpot amounts.

Credit-receiving module 130 includes one or more mechanisms for receiving credits for use in placing wagers in the game. Exemplary credit-receiving mechanisms include a coin acceptor, a bill acceptor, a ticket reader, and a card reader. Some embodiments combine a bill acceptor and ticket reader into a single unit. The card reader, in some embodiments, accepts magnetic cards and/or smart (chip) cards that are coded with money and/or that designate one or more financial accounts.

User interface 140 includes one or more user-interface devices, such as push-buttons 142 and pull arm 144. In the exemplary embodiment, push-buttons 142, which are based on electromechanical or touch-screen technology, include one or more “bet” buttons for wagering, a “play” button for commencing play, a “collect” button for cashing out, a help” button for viewing a help screen, a “pay table” button for viewing the pay table(s), and a “call attendant” button for calling an attendant. Also, in the exemplary embodiment, one or more of the buttons (or other input devices) allows player to select from two or more denominations, such as $0.01, $0.05, $0.10, $0.25, $0.50, $1.00, $2.00, $5.00, $10.00, $20.00, which define the minimum wager for a game on the machine. (In some embodiments, machine 100 is a single-denomination machine and thus lacks buttons for selecting denominations or has disabled such buttons.)

Other embodiments—such as those that employ graphical user interfaces, keyboards, trackballs, and/or other pointing devices—offer wider ranges of choices. For example, some embodiments provide a first menu that allows users to select from a set of sub-dollar denominations, a second menu that allows uses to select from a set of denominations between one-to-ten-dollars denominations, and a third menu that allows users to select from a set of denominations greater than ten dollars. Still other embodiments may allow users to arbitrarily input numerical values to define a denomination.

Payout module 150 includes one or more mechanical and/or electronic mechanisms for outputting credits, in a tangible or intangible form, to a player. In the exemplary embodiment payoff module 150 can output credits to a card or coins to an output tray in response to control signals from control module 160.

Control module 160, which controls general operation of gaming machine 100, includes a processing unit (or controller) 162 and a memory unit 164. Processing unit 162 can take any number of forms, including one or more microprocessors, microcontrollers, or application specific integrated circuits. Memory 164, which in the exemplary embodiment takes any form or combination of volatile or nonvolatile electronic, magnetic, or optical memories, includes a game control module 1642.

Game control module 1642 stores game-related instructions and/or data for coordinating and directing operation of processing unit 162 and/or other portions of gaming machine 100 to implement one or more interactive wagering games, such as multi-line slots or video poker, on the gaming machine.

### Exemplary Method of Operation

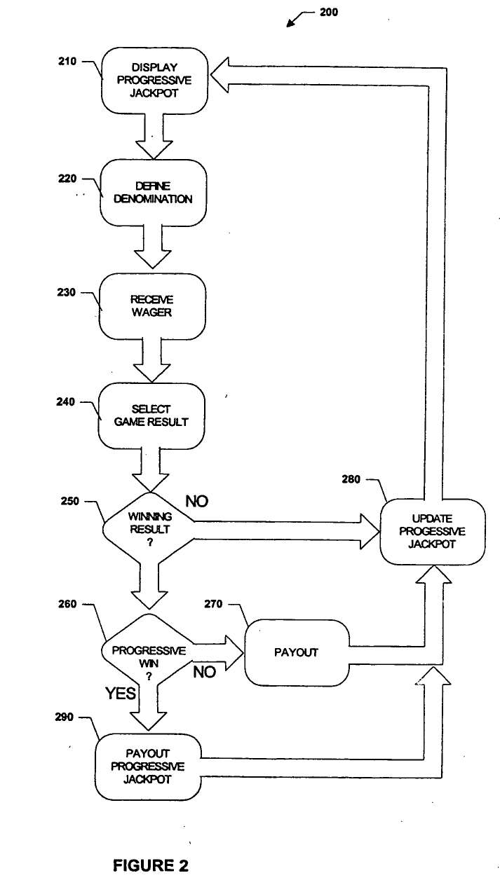

More specifically, FIG. 2 illustrates a flow chart 200 of an exemplary method of operation that is embodied in game control module 1642. Flow chart 200 includes process blocks 210-290, which are arranged and described in a serial sequence in the exemplary embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more interconnected hardware modules with related control and data signals communicated between and through the modules. Thus, the exemplary process flow applies to software, hardware, and firmware implementations.

At block 210, the method begins with display of a progressive jackpot amount. In the exemplary embodiment, this entails displaying a single progressive jackpot amount J on secondary display 120 of gaming machine 100. Execution continues at block 220.

Block 220 entails defining a game denomination. In the exemplary embodiment, this entails a player at gaming machine 100 using one or more portions of user interface 100, such as push buttons 142, to select one of a set of available denomination options, such as $0.10, $0.05, and $0.01. Once a selection is made, execution continues at block 230.

Block 230 entails receiving a wager. In the exemplary embodiment, receiving the wager entails receiving a number of coins or tokens at credit-receiving module 130. In some embodiments, receiving the wager entails receiving one or more data inputs from the player that define the wager amount and then transferring the defined wager amount from a casino debit card or other financial account associated with the player to a casino account. Execution proceeds to block 240.

Block 240 entails selecting a random game result at one or more of the gaming machines. In the exemplary embodiment, selecting the random game result entails use of one or more random number generators or other conventional methods of selecting one or more of a number of possible game results. Also, in the exemplary embodiment, selection of the random game result occurs in response to a player pushing one of push-buttons 142 or actuating pull-arm 144. Execution then continues at block 250.

Block 250 entails determining whether a winning game result has occurred. In the exemplary embodiment, a winning game result occurs when the game result matches a predetermined game result, such as a particular combination of reel symbols in at least one payline of a multi-line slots game, or a particular hand of cards in a poker game. If the determination is that a winning game result has occurred, execution advances to block 260.

Block 260 determines whether the winning game result is a winning progressive event. In the exemplary embodiment, this entails determining whether the amount wagered at block 230 qualifies the player for an opportunity to win the progressive jackpot (or one or more other progressive jackpots.) More specifically, this entails determining whether the amount wagered equals the maximum amount allowed to be wagered at the gaming machine based on the selected denomination. Some embodiments use other criteria for determining eligibility for progressive jackpots. If the wager amount does not qualify for a progressive jackpot, execution proceeds to block 270, and if it does qualify, then execution proceeds to block 290.

Block 270 entails payout of an amount based on a non-progressive payout schedule. In the exemplary embodiment, this payout entails using payout module 150 to dispense coins, credits, or a combination of coins and credits to the player. The payout amount, typically several orders of magnitude less than the progressive jackpot amount, is based on the probability of selecting the winning game result at random from all possible game results. Execution then proceeds to block 280, which entails updating the progressive jackpot amount, by for example, increasing the progressive jackpot amount based on some percentage of the amount wagered at block 230.

Block 290 entails awarding at least a portion of one or more progressive jackpot amounts to the winner player. In the exemplary embodiment, this award occurs through use of payout module 150 to dispense coins, credits, or a combination of coins and credits to the player. Alternatively, this award may be hand paid by an attendant if the award is higher than a maximum amount payable by the machine. Additionally, the amount awarded is equal to the product of the single, currently displayed progressive jackpot amount (on secondary display 120 or on a central progressive display if the machine is in a progressive system) and the ratio of the selected denomination for the winning machine to the maximum available denomination. This computation can be expressed as
J(d)=(d/D)*J(D), Eq. (1)

where d denotes the denomination of the game played to achieve the winning game result; D denotes the maximum available domination for the gaming machine; and J(D) denotes the progressive jackpot available when playing at the maximum denomination. The table below illustrates an exemplary partial payout schedule for a progressive jackpot of $100,000. Some embodiments implement such a payout schedule completely or partially in a lookup table.

| D | d/D | J(d) |
|---|---|---|
| $0.10 | 1 | $100,000 |
| $0.05 | 0.5 | $50,000 |
| $0.01 | 0.1 | $10,000 |

Equation (1) derives from the notion of a ‘fair’ game, in which the player's expected value (chance of winning times the ratio of winnings to amount wagered) is independent of the denomination of the game being played. This notion can be expressed in mathematical terms as:
P(d1)*[J(d1)/[d1*C(d1)]]=P(d2)*[J(d2)/[d2*C(d2)]], Eq. (2)
for all available d1, d2, where d1 and d2 respectively denote denomination of a first game machine in dollars and a second game in dollars; P(d1) and P(d2) respectively denote the probabilities of jackpot on the game of denomination d1 and the game of denomination d2; J(d1) and J(d2) respectively denote the progressive jackpot values in dollars awarded on game of denomination d1 and the game of denomination d2; and C(d1) and C(d2) respectively denote the numbers of coins (or tokens) required to qualify for the progressive jackpot on a game of denomination d1 and the progressive jackpot on a game of denomination d2. When the probability of winning the jackpot is independent of denomination, that is P(d1)=P(d2), and requires the same number of input coins to qualify for the progressive jackpot, that is C(d1)=C(d2), equation (2) simplifies to
J(d1)/J(d2)=d1/d2, for all d1,d2. Eq. (3)
Which is equivalent to stating that “when the coins required to qualify for the progressive jackpot and probability of winning the jackpot are equal for all game denominations, the dollar amounts awarded for a jackpot win on the machine is in the same ratio as the respective denominations.” Rearranging equation (3) yields
J(d1)=[d1/d2]*J(d2), for all d1,d2. Eq. (4)
In the case of a single progressive jackpot where play at maximum denomination D awards the entire progressive jackpot and play at lesser denominations awards only a portion of the jackpot, a winning progressive event at any machine results in award of jackpot of value J(d), equation (4) reduces to Eq. (1), which for convenience is repeated below:
J(d)=(d/D)*J(D), for all d. Eq. (1)
Equation (1) stands for the proposition that “when the coins required for jackpot and probability of jackpot are equal and independent of the game denomination, the jackpot awarded is the portion of the total progressive jackpot determined by the ratio of the game denomination to the maximum denomination.”

For instance, one system of three machines with selected or fixed dominations of $0.10, $0.05, and $0.01 denominations, and a wager of 100 coins required for jackpot eligibility, awards a jackpot of $100,000 for winning progressive event on the $0.10 game, the maximum denomination. The table below demonstrates that a payout schedule in accord with equation (1) results in equal expected values for each selectable game denomination.

| | | | | | J(d)/ | P(d) * (J(d)/ |
|---|---|---|---|---|---|---|
| D | C(d) | P(d) | d/D | J(d) | [d*C(d)] | [d*C(d)]) |
| $0.10 | 100 | 1/1,000,000 | 1 | $100,000 | 10000 | 0.01 |
| $0.05 | 100 | 1/1,000,000 | 0.5 | $50,000 | 10000 | 0.01 |
| $0.01 | 100 | 1/1,000,000 | 0.1 | $10,000 | 10000 | 0.01 |

From block 290 execution returns to block 280, which updates the jackpot, in this case to reflect award of at least a portion of the progressive jackpot amount. If less than the entire progressive jackpot amount is awarded, the amount awarded is subtracted from the current progressive jack amount. Execution then returns to block 210.

### Exemplary Progressive Gaming System

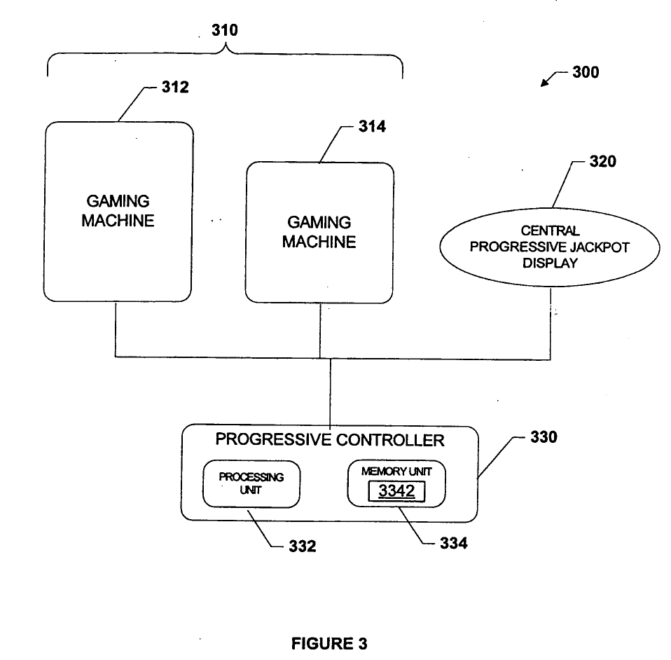

FIG. 3 shows an exemplary progressive gaming system 300, which implements a progressive game in accord with that described for gaming machine 100. System 300 includes a set of gaming machines (or terminals) 310, a central progressive display 320, and a progressive game controller 330, which are operatively coupled together to define a local- or wide-area progressive network.

Gaming machines 310 include a plurality of gaming machines, of which gaming machines 312 and 314 are generally representative. In the exemplary embodiment each of these machines has a structure and/or functionality similar to that of exemplary gaming machine 100 in FIG. 1. (In some variants of the exemplary embodiment, one or more functions of control module 160, as shown and described, are implemented outside of the gaming machines in other portions of the system 300, such as progressive controller 330.)

Display 320 includes one or more video, LCD, or LED display devices for use in displaying at least one progressive jackpot value. In the exemplary embodiment, the display displays only one progressive display value; however, the same value may be displayed multiple times to facilitate multiple points of view. Also, in the exemplary embodiment, the display is generally positioned in an area central to gaming machines 310. For embodiments with widely dispersed gaming machines, display 320 includes multiple display units that display the same progressive jackpot value, with each display unit central and proximate to a subset of the gaming machines in the system.

Progressive controller 330, which communicates with each of the gaming machines and with central display 320 via a wired or wireless local- or wide-area network, includes a processing unit (or controller) 332 and a memory unit 334. Processing unit 334 can take any number of forms, including one or more microprocessors, microcontrollers, or application specific integrated circuits. Memory 334, which in the exemplary embodiment takes any form or combination of volatile or nonvolatile electronic, magnetic, or optical memories, stores machine and/or processor-executable instructions 3342 for coordinating and directing operation of processing unit 334 and/or portions of gaming machine 310, and central display 320 to implement a progressive gaming system.

In the exemplary embodiment, instructions 3342 direct processing unit 332 to implement or facilitate the functions previously described for blocks 210, 270, and 280 in FIG. 1. In one variant of this embodiment, the award for a winning progressive game result is computed based on the maximum of all denominations that are available for play in the entire set of machines in the progressive system.

The embodiments described above are intended only to illustrate and teach one or more ways of making and using the present invention, not to restrict its breadth or scope. The actual scope of the invention, which embraces all ways of practicing or implementing the teachings of the invention, is defined only by one or more issued patent claims and their equivalents.

1. A method comprising:
providing a gaming machine having a displayed progressive jackpot amount;
receiving user input defining a denomination for a game at the gaming machine;
receiving a wager based on the defined denomination;
selecting a winning progressive game result in response to receiving the wager; and
awarding an amount less than the displayed progressive jackpot amount in response to selecting the winning progressive game result, with the amount rewarded based on the amount of the displayed jackpot and a ratio of the defined denomination to a maximum available denomination.

2. The method of claim 1, wherein the gaming terminal provides an option to choose one of two or more denominations, and wherein the maximum denomination is the maximum of the two or more denominations.

3. The method of claim 1, wherein the maximum denomination is the maximum denomination available within a set of two or more gaming terminals.

4. The method of claim 1, wherein the gaming terminal is coupled to a progressive controller that is coupled to at least one other gaming terminal having an associated denomination, and wherein the maximum denomination is the maximum of a combined set of the two or more denominations.

5. A gaming machine comprising:
a display for displaying a progressive jackpot amount;
means for accepting user input defining or selecting a denomination for the machine;
a credit acceptor for receiving a wager based on the defined denomination;
a game module for selecting a winning progressive game result in response to receiving the wager; and
means for awarding an amount less than the progressive jackpot amount in response to selecting the winning progressive game result, with the amount rewarded based on a ratio of the defined denomination to a maximum available denomination.

6. The machine of claim 5, wherein the means for accepting user input defining or selecting a denomination, provides an option to choose one of two or more denominations, and wherein the maximum available denomination is the maximum of the two or more denominations.

7. The machine of claim 5, wherein the maximum available denomination is the maximum denomination available within a set of two or more gaming machines.

8. A progressive gaming system comprising:
a first gaming machine for receiving a first wager of a first number of coins c1 of a first denomination d1, playing a first game of chance having a first probability of providing a winning result of P(d1) based on the first wager, with the winning result associated with at least a portion of a progressive jackpot J(d1) and having a corresponding first expected value defined as P(d1)*[J(d1)/(d1*c1)]; and
a second gaming machine for receiving a second wager of a second number of coins c2 of a second denomination d2, playing a second game of chance having a second probability P(d2) of providing a second winning result based on the second wager, with winning result associated with at least a portion of a progressive jackpot J(d2) based on a result of playing the second game of chance, with the second wager having a second expected value defined as P(d2)*[J(d2)/[d2*c2)]] which is substantially equal to the first expected value.

9. The system of claim 8, wherein P(d1)=P(d2).

10. The system of claim 8, wherein c1=c2 and c1 and c2 denote the respect number of coins required to qualify for respective jackpots J(d1) and J(d2).

11. The system of claim 8 wherein the first gaming machine is a multi-denomination machine and the second gaming machine is a single-denomination machine.
